(19) United States
(12) Patent Application Publication
(10) Pub. No.: US 2024/0051217 A1
(43) Pub. Date: Feb. 15, 2024

(54) TUBE HEATER AND SEALER AND METHOD FOR SEALING THERMOPLASTIC TUBES AND PIPES

(71) Applicant: Tomas PINK, Beromünster (CH)

(72) Inventor: Tomas PINK, Beromünster (CH)

(21) Appl. No.: 18/260,522

(22) PCT Filed: Jan. 3, 2022
(86) PCT No.: PCT/EP2022/050027

§ 371 Date: Jul. 6, 2023

(30) Foreign Application Priority Data
Jan. 7, 2021 (EP) 21150510.2
Aug. 10, 2021 (EP) 21190679.7

(51) Int. Cl. B29C 57/10; B29C 35/08

(52) U.S. Cl. CPC B29C 57/10; B29C 35/0805; B29C 2793/0027; B29C 2035/0811; B29L 2023/005

(57) ABSTRACT

An apparatus and method of closing a wide variety of thermoplastic tubes, in particular with Shore hardnesses of around 50 (A) to above 100 (A), where the tubes having inside diameters of 1.6 mm to 35 mm and/or wall thicknesses of 0.8 to 4.8 mm. The method involves use of a tube heater having at least one heating element. The heating element has at least four heatable regions which are movable with respect to one another. The tube heater is configured to enclose, in the applied state, at least 75% of the circumference of the tube while bearing against the latter over its circumference at at least four points which are spaced apart from one another. One of the key advantages is that, prior to compression, the tube can already have been heated at a plurality of points on the tube.

The invention relates to the heating and sealing of thermoplastic tubing and pipes.

The inductive sealing and cutting off of tubing is known, for example, from CN106808040A. A variable open induction coil for induction in metal pipes for the purpose of soldering is also known from CN103596310 A. It is also known from US2017252872A 1 to wrap metal pipes with a metal foil and to melt it inductively for the purpose of soldering. Also known are induction soldering pincers, for example from U.S. Pat. No. 3,365,563A. It is also known that metal pipes can be separated by inductive heating, as described in JPS51134351.

For sealing tubing, it is also known from US2009/302033 A1 to carry out heating by means of radio waves under the action of force.

It is also known, for example from EP2251183 A2, to push a ring or half rings made of plastically deformable material onto an elastic tube and to crimp this(s). However, the closure thus achieved is not fused, less tight and/or less reliable. The application of heat and the heat fusion of the tubing material is not mentioned. The hoses mentioned are exclusively elastic hoses, the use of thermoplastic elastomers is not disclosed.

From another field of technology, the bonding of two pipes, it is known to place a heating ring around the connection joint for the purpose of curing the adhesive, for example from DE1704131 A1. It is also known to place a sleeve over the connection joint and weld it inductively, for example from WO 2012051719 A1 or EP2452805 A1.

It is also known from WO 2019174843 A1 to interpose a metallic element between two plastic parts and inductively heat it for the purpose of melting and fusing these two plastic parts.

It is also known from a further field of technology to thermally seal plastic bags under pressure. In this respect, it is known from U.S. Pat. No. 2,638,964 A to use an intermediate layer, in particular made of Teflon, in order to reduce adhesion.

Basically, when closing thermoplastic tubing, it is very important to create a stable, pressure-resistant seal (closure of the tubing) quickly and with a reproducible quality.

In the prior art, only two opposing, parallel surfaces are heated for the thermally assisted closure of thermoplastic tubing. This means that the tube must first be compressed, then it is heated to a significant extent and thereby fused. Harder hoses in particular cannot be sealed by such a process and, the process takes a long time. In addition, the hose has to be cooled back after sealing.

On object of the invention is to provide a corresponding device, a method and a utilization that make it possible, to seal a wide variety of thermoplastic tubing, in particular from Share hardness of 50 (A) to over 100 (A), some of which already as pipes are designated, with inner diameters of 1.6 mm to 35 mm and/or wall thicknesses of 0.8 to 4.8 mm. A lightweight, handy device, suitable for clean rooms, i.e. in particular not emitting, collecting, and/or releasing any particles.

At least the part of the device that is placed on the tube to be sealed/closed should be compact, lightweight and/or one-handed and designed without particle emission and/or without air circulation. The hose and/or the seal should also have the lowest possible temperature and/or thermal energy after sealing.

One of the main advantages of the invention is that the tubing can be heated before it is compressed.

The task is solved by a hose heater, especially for closing of thermoplastic tubing, especially hoses made of thermoplastic elastomer, having at least one heating element, especially an inductive and/or resistive one. The heating element has at least four, in particular more than six, areas that can be moved relative to one another, can be inductively and/or resistively heated, and is set up to be placed on the tubing from a direction perpendicular to the longitudinal extension of a hose, the hose having an outer diameter in the range of 3.2 mm to 45 mm and/or an inner diameter in the range from 1.6 mm to 35 mm and/or wall thicknesses in the range from 0.8 to 4.8 mm. The tubing heater is set up so that when it is placed on the tubing, it rests against the tubing over its circumference at at least four spaced-apart locations to enclose at least 75% of its circumference. In particular, these are points that are distributed over the circumference of the tubing in such a way that they span at least 200° and/or at least 55% of the circumference of the tubing and/or at least two of which are opposite one another, in particular diametrically, and/or between which there is an angle in the range from 90 to 150°, in particular up to 135°, or a tubing circumference section in the range from 8% to 35% of the tubing circumference. In particular, the tubing heater is set up to enclose all tubing with outside diameters in at least one-fifth of the range from 3 mm to 45 mm, i.e., for example, all thermoplastic tubing with an outside diameter in the range of 21 to 30 mm or from 30 to 40 mm.

The heating element is designed to be deformable in such a way that a cross section enclosed by it can be reduced and/or flattened by compressing and/or pulling the heating element, specifically by at least 30%, in particular at least 50%. The reduction of the cross-section enclosed by the tubing heater is to be considered in particular in relation to the enclosed cross-sectional area and/or to an extent of the cross-section, in particular the extent of the cross-section in the direction of the minimum extent of the cross-section in the reduced state. In this case, the cross section is to be determined in particular in the plane perpendicular to the longitudinal extent of the tubing held. In particular, the heating element is designed in such a way that the compression causes a non-elastic material deformation of the heating element. The heating element is set up in particular in such a way that the compression without a tubing lying in between requires a force of less than 100 N, in particular less than 10 N and/or more than 0.05N, in particular more than 0.1N and/or less than 1 kN. Because the compression causes, in an advantageous embodiment, a non-elastic material deformation of the heating element, it is possible to prevent or reduce an expansion of the tube after compression by the heating element even after removal of an external force acting on it.

The mutually movable, in particular inductively and/or resistively heatable areas are formed by, in particular one, plate-shaped element(s), also heatable plate(s). Between at least two, in particular more than three, pairs of adjacent plate-shaped elements, there is a joint and/or a weakened material which allows the angle of the plate-shaped elements of the respective pair to be changed relative to one another. A material weakening is in particular over at least 80% of, in particular the entire, width of the heating element and/or the, in particular inductively and/or resistively, heatable areas and/or over at least 80% of, in particular the entire extent of the heating element and/or or the, in particular inductively and/or resistively heatable areas perpendicular to the plane of the enclosed cross-section and/or perpendicular to the surface normals on heatable plates adjoining one another and the weakening of the material, it stretches out. A material weakening is in particular designed such that the material weakening is less than the thickness of the adjacent heatable plates by at least 30%, in particular at least 50%, in particular over their entire extent.

The task is also solved by a thermoplastic tubing, in particular a tubing made of thermoplastic elastomer, having at least one, in particular inductively and/or resistively heatable clip and/or at least one, in particular inductively and/or resistively heatable ring that/which encloses the tubing, the ring and/or the clip being in particular a tubing heater according to the invention. In particular, two clasps and/or rings are arranged on the tube at a maximum distance of 5 mm with a gap between them, in particular of at least 0.2 mm. In particular, the at least one ring/the at least one clip is firmly arranged on the tubing, in particular clamped, crimped, pinched and/or partially penetrating into the wall of the tubing and/or fused to it.

The task is also solved by a tubing sealing device actuator, in particular in the form of pliers and/or two legs and/or jaws connected by a hinge, which have means for attaching a tubing heater, with the tubing heater having at least one, in particular inductive and/or resistive heatable heating element, wherein the heating element has at least four, in particular more than six, mutually movable, in particular inductively and/or resistively heatable areas and the heating element is set up to enclose a tubing with an outer diameter in the area from 3 mm to 45 mm, being in contact with it over its circumference at at least four points spaced apart from one another, and wherein the heating element is designed to be deformable in such a way that a cross section enclosed by it is reduced by at least 30%, in particular at least 50%, and/or can be reduced in its extent in one direction of the cross section by at least 30%, in particular at least 50%, in particular can be flattened, with the tubing accommodated therein. The tubing sealing device actuator also has means, in particular comprising at least one pneumatic cylinder, set up to deform the tubing heater that is accommodated in such a way that the cross section enclosed by it is reduced by at least 30%, and at least one means for effecting inductive and/or resistive heating of the heating element, in particular at least one induction coil for inductive, in particular resistive, heating of the heating element and/or contact means for electrically contacting the heating element(s) of the tubing heater.

In particular, it has at least one means for heating the heating element, for example a power supply, but in particular at least one induction coil for inductive and/or resistive heating of the heating element. However, it is also possible to provide a power supply and electrical contacts for electrically contacting resistive heating elements. With regard to the properties of the removable tubing heater, the above applies in particular.

The task is also solved by a tubing sealing device actuator, in particular in the form of pliers and/or two jaws and/or shanks connected by a hinge, for closing thermoplastic tubing and/or pipes, in particular tubing and/or pipes made of thermoplastic elastomer, having at least one, in particular inductively and/or resistively heatable heating element, wherein the at least one heating element has at least four, in particular more than six, areas that can be moved relative to one another, in particular inductively and/or resistively heatable areas and in particular are fixed to the tubing sealing device actuator and the heating element is set up, in particular, to be able to be placed on a tubing with an outside diameter in the range of 3 mm to 45 mm from a direction perpendicular to the longitudinal extent and to be enclosing the tubing at least at four spaced-apart points over at least 75% of its circumference and wherein the tubing sealing device actuator is set up to move the at least one heating element, in particular by means of at least one means for deforming, in particular by means of at least one pneumatic and/or hydraulic cylinder, an electric drive or a manual drive that a cross section enclosed by it, in particular of a thermoplastic tube, can be reduced by at least 30%, in particular at least 50%, and/or its extension in one direction of the cross section can be reduced by at least 30%, in particular at least 50%, wherein the tubing sealing device actuator has at least one means for heating the heating element, in particular at least one induction coil for inductive and/or resistive heating of the heating element.

In an alternative configuration of the devices, methods and/or utilizations, the at least one heating element needs not to be inductively heatable and/or inductively heated, but can be designed as any heating element and/or as arbitrarily heatable, for example as an electrical resistance heating element and/or resistively heatable element.

In this text, heatable is understood to mean, in particular, actively heatable and/or in particular a means for generating heat from another form of energy, in particular electric current. A heatable area is therefore in particular an area that has means for converting energy into heat, in particular from electrical energy, for example a resistive heating element. A heatable heating element is therefore in particular a heating element which has means for converting energy into heat, in particular from electrical energy, for example a resistive heating element. A heatable plate is therefore in particular a plate which has means for converting energy into heat, in particular from electrical energy, for example a resistive heating element. Such means for converting energy into heat, in particular from electrical energy, for example a resistive heating element, can be supplied with electricity, for example inductively or by means of electrical contacts.

In particular, electricity is fed into the means for conversion into heat, in particular inductively, in particular a ring current.

The means for generating heat and/or the heating element are in particular made of metal and/or are electrically conductive and/or are integrated in the tubing heater and/or in the area and/or in the plate, in particular in such a way that they are at least on the outer circumference, in particular not at all, exposed. As a result, safety can be increased and heating can be made more efficient and/or more even. In particular, the means for heating are designed for simultaneous and/or joint operation, in particular in such a way that they can be activated and deactivated at the same time by a single action.

In particular, the means for heating and/or its effecting can be controlled and/or regulated, in particular so that the amount of heat generated, in particular per unit of time, can be adjusted.

In particular, the means for generating heat, the tubing heater and/or the tubing are set up in such a way, that the generation of heat can be interrupted and/or terminated at any time. In particular, the method is carried out and/or the tubing sealing device actuator is designed in such a way that when a temperature is reached, in particular measured by a temperature sensor, in particular on the tubing and/or on the tubing heater and/or on the heating element, and/or when a predetermined cross section is reached and/or diameter and/or maximum extent of the cross section in a specified direction and/or a specified reduction in cross section and/or diameter and/or a specified reduction in a maximum extent in a specified direction are reached, which is also caused, for example, by a specified distance of an actuator may be given, in particular by squeezing and/or falling below a force necessary for the compressions, the heating is terminated and/or reduced.

This can be done, for example, by reducing and/or interrupting the current flow, in particular through the resistive heating element and/or the induction coil.

The means for deforming are set up in particular to press the tubing heater together and/or flatten it and/or to pull it apart at opposite points, in particular with a force in the range from 10 N to 1 kN. In particular, in the case of being pulled apart, they are designed to hold two ends of the hose heater together at a common point.

The task is also solved by a method for sealing a thermoplastic tubing, in particular a tubing made of thermoplastic elastomer, comprising the following steps:
at least partially enclosing a section of the tubing with at least one, in particular inductively and/or resistively, heatable heating element, in particular with a tubing heater according to the invention, so that the heating element rests at least partially on the circumference of the tubing and/or use of one thermoplastic tubing with at least one enclosing, in particular inductively and/or resistively heatable heating element, in particular with a tubing heater according to the invention, wherein the heating element rests at least partially on the circumference of the tubing and
enclosing the tubing and/or applying the at least one heating element on at least two opposite sides on and/or adjacent to the section of the tubing with a means for compressing the tubing, in particular a tubing sealing device actuator according to the invention, and heating the heating element, in particular by means of an electromagnetic field, and heating the tubing with the heated heating element, in particular up to at least the circumference, in particular over the entire thickness of the hose wall of the tubing, the Shore (A) hardness of the section is reduced by at least 30% and/or at least at the circumference, in particular over the entire thickness of the hose wall, the glass temperature and/or glass transition temperature has been reached,
squeezing the tubing with the means for squeezing the tubing, in particular during the heating of the heating element, in particular by means of an electromagnetic field, and/or while the heating of the section is continued with the heated heating element, and
removing the compression means and, in particular, the heating element.

In this case, the tubing is in particular completely enclosed over at least 75% of its circumference. During the enclosing process, the heating element rests on its circumference, in particular at at least four points spaced apart from one another, with regard to which the statements made above apply in particular.

The task is also solved by using at least one, in particular inductive and/or resistive, heatable heating element to close a thermoplastic tubing, in particular tubing made of thermoplastic elastomer, with a section of the thermoplastic tubing being connected or going to be connected to the at least one, in particular inductive and/or resistive, heatable heating element and, the at least one heating element is heated, in particular inductively and/or resistively, and thence the section is heated, in particular up to at least the circumference, in particular over the entire thickness of the hose wall, the Shore (A) hardness of the section is reduced by at least 30% and/or at least on the circumference, in particular over the entire thickness of the tubing wall, the glass transition temperature is reached, and squeezing the tube in and/or adjacent to the section, in particular while heating of the heating element by the electromagnetic field and/or heating of the section with the heated heating element is continued.

In this case, the tubing is enclosed to at least 75% of its circumference, in particular completely. During the enclosing process, the heating element rests on its circumference at at least four points spaced apart from one another, with respect to which the statements made above apply in particular. With regard to the enclosing, the statements made above regarding the tubing heater and/or the method apply in particular.

In this document, the reduction in Shore hardness is to be determined in particular in relation to the state before heating and/or at 20° C.

In particular, the hose is compressed directly adjacent to the at least one heating element, in particular at a distance of less than 5 mm and/or by compressing the heating element.

In particular, the section of the thermoplastic tubing with two, in particular inductively and/or resistively heatable, heating elements, which are arranged adjacent to one another on the tubing with a distance in the range of 0.2 mm to 5 mm, in particular with a gap in between, is/will be/or are enclosed and both heating elements, in particular inductively and/or resistively, are heated and/or both heating elements are pressed together, in particular at the same time. In particular, the tubing is severed between the heating elements, in particular with a blade that is heated in particular, in particular inductively and/or resistively.

Compressing takes place in particular with a force in the range from 10 N to 1 kN.

The object is achieved in particular by a tubing closure system having at least one, in particular more than one, tubing heaters and/or tubing(s) according to the invention, having at least one, in particular more than one, different inner diameters and/or cross-sections, and at least one, in particular exactly one, inventive tubing sealing device actuator.

In particular, the tubing sealing device actuator is set up to close a tubing according to the invention. In particular, the use and/or the method takes place with a tubing, tubing heater and/or tubing sealing device actuator according to the invention.

With particular advantage, the tubing heater is suitable for being pressed together and/or flattened with the tubing sealing device actuator. The tubing sealing device actuator is particularly advantageously set up to compress and/or flatten the tubing heater. With special advantage is the tubing heater and/or tubing sealing device actuator designed to carry out the method according to the invention and/or for the use according to the invention. The method according to the invention and/or the use according to the invention with the tubing heater according to the invention and/or the tubing sealing device according to the invention is advantageously carried out.

The tubing heater and/or tubing should only be made of “single-use” material.

In this document, “single-use” material is understood to mean a material or a mixture of materials which, when disposed of, in particular dumped and/or incinerated, in particular when incinerated at temperatures in the range of 800-1150° C., in particular 800° C. and 900° C., and/or in the case of fluidized bed combustion and/or grate combustion, do not release any hazardous by-products or emissions and either burn without residue and/or decompose or leave only residues which are harmless to people and the environment and/or those that meet the requirements of the BlmSchG, the BlmSchV and/or Industrial Emissions Directive 2010175/EU (Integrated Pollution Prevention and Control) in the latest and/or valid version at the time of registration, in particular for combustion at temperatures in the range of 800-1,150° C., in particular 800° C. and 900° C., and/or in the case of fluidized bed firing and/or grate firing. They preferably contain no rare elements or other valuable materials, in particular no permanent magnets. It is preferably plastic, enamel, ceramic, steel, tungsten carbide, titanium nitride, aluminum oxide, metal and semimetal nitrides, metal carbides, metal and semimetal oxides, glass and/or carbon composite material, glass and/or Carbon fibers, aramid, aramid resin and/or aluminum and aluminum alloys, magnesium alloys, preferably plastic. Examples of possible plastics are polypropylene, polyethylene, polyvinyl acetate, polyethyl vinyl acetate, PEEK, PET, polyamides and polyimides.

In particular, the tubing heater is designed to heat to at least 300° C. without melting. In particular, the tube is heated to no more than 300° C. and/or only to below the decomposition temperature of the tubing.

In particular, the heatable plates of the heating element have a thickness in the range from 0.2 to 5 mm and/or a width and/or extension perpendicular to the surface normals on heatable plates bordering one another and/or on the weakening of the material in the range from 50% to 200% of the diameter of an inner circle of the enclosed cross-section and/or maximum inventive enclosable hose.

The heating element advantageously has thermal insulation, in particular circumferentially, in particular around the mutually movable, in particular inductively and/or resistively, heatable areas and/or outside the enclosed cross-section, thermal insulation, in particular in the form of ceramic elements, elements made of plastic and/or glass, In particular insulation panels, in particular one per area and/or heatable panel. In particular, the thermal insulation cannot be heated inductively and/or resistively and in particular is designed in such a way that it does not impede the inductive and/or resistive heating of the heating element or only impedes it to a negligible extent. In particular, it is non-conductive and/or non-magnetic. In particular, it is solid up to at least 300° C. and non-flammable. In particular, it is designed in such a way that it withstands the force required for compression, in particular of up to 1 kN. In particular, the insulation is designed in such a way that it projects beyond the heatable plates in the direction perpendicular to the plane of the enclosed cross-section and/or perpendicular to the surface normals, in particular by a length in the range of at least 5% and/or in the range up to a maximum of 25% of the extent of the heating panels and/or the insulation in this direction.

With particular advantage, the heating element, which can be heated in particular inductively and/or resistively, has only one layer on at least half of the circumference of the cross section arranged around the cross-section it encloses and/or wound a maximum of one and a half times around the cross-section it encloses. This allows the heating to be efficient and the heating element easy to put on the hose.

The hose heater is particularly advantageously designed to be flexible and/or with at least three joints and/or a weakening of the material and/or the areas are each designed to be stiff. Stiff areas with weakened material in between are preferred as joints. This allows a particularly reliable closure when pressing together, especially when the force acts only in a few places and holding together is secured even after the force has been removed. In particular, the heating element is designed in such a way that the cross section can be reduced by changing the angle of the neighboring, in particular all neighboring, in particular inductively and/or resistively, heatable areas via the joints and/or material weaknesses.

With particular advantage for the closure of the hose, the at least one heating element is designed to be circumferential, that is to say closed in a ring shape or set up to form such a ring closure. This can be done by connecting two ends of the heating element. The connection can, for example, be form-fitting or be established by squeezing, fusing and/or by clamping. The at least one heating element is particularly advantageously designed to be openable and/or closable.

In one embodiment, the tubing heater can have at least two heating elements that can be connected to one another, in particular on both sides. This enables easy attachment to the hose from two sides.

In particular, if the cross-section is to be reduced by tension, the at least one heating element can have at least two mechanical contact points at two spaced apart, in particular opposite, locations which are arranged in such a way that pulling the contact points apart results in a reduction of the enclosed cross-section.

With particular advantage, the at least one heating element and/or its areas and/or heatable plates have a specific heat capacity of less than 1000 J/K/kg. This enables a quick procedure with a low risk of injury.

The tubing heater, in particular the heating element and/or insulation, is/are particularly advantageously designed to be severed. In particular, it is/are in two parts with an intermediate gap, the separation takes place in particular parallel to the cross-sectional plane. In particular, the tubing heater can consist of two identical elements between which there is in particular a gap in the range of 0.2 to 5 mm and/or which is/are arranged on the tubing with such a gap. This makes it possible to cut between these elements, for example by means of a knife/blade. There may be a connection between these elements that can be severed with. However, this connection is in particular made in such a way that it can be cut through more easily with a blade than the heating element and/or insulation, in particular on both sides of the gap. The use of elements on both sides of the separation of the tubing promotes the stability of the seal until both tubing parts have cooled down completely.

According to the invention and with particular advantage for the stability of the seal until the tubing/tubing parts have completely cooled down, the tubing heater, in particular each of its halves/elements geared for separation, is designed in such a way that its cross-sectionally reduced shape and/or the reduced cross-section at least counteracts to maintain a force of 1 N pushing it apart insofar as the enclosed reduced cross-section not increased by more than 10%, preferably substantially and/or fully maintained. The 10% are to be assessed in particular based on the reduced cross-section. The force is exerted in particular by the compressed tubing.

With particular advantage for the stability of the seal until the tubing/tubing parts have cooled completely, the method is carried out in such a way that the reduction in the cross section of the tubing caused by the compression is maintained at least until it has cooled completely, so that the enclosed reduced cross section does not change increased by more than 10%, preferably essentially and/or completely retained. In particular, this is achieved by the tubing heater and/or the at least one heating element, in particular in that the latter is designed in such a way that at least against a force of 1 N pressing it apart the reduced cross-section of the tubing is maintained in such a way that the enclosed reduced cross-section of the tubing does not increase by more than 10%, preferably is substantially and/or completely maintained. The 10% are to be assessed in particular based on the reduced cross-section. The force is exerted in particular by the compressed tubing.

The tubing heater, in particular the heatable plates and/or halves/elements, particularly advantageously has/have at least one hole and/or recess, in particular holes and/or recesses, which is/are set up to allow thermoplastic material to pass during compression. In this way, the tubing heater can and is advantageously partially pressed into the tubing or tubing material is pressed through it when it is compressed. As a result, the tubing heater can be firmly connected to the tubing and its stabilizing effect can be further increased.

In particular, the means for deforming the tubing sealing device are actuator by at least one pneumatic and/or hydraulic cylinder, and/or at least one cuff for injecting compressed air and/or fluid and/or a servomotor or electric motor and/or a transmission, in particular for manual actuation.

In particular, the tubing sealing device actuator is set up to move at least one heating device, in particular it is set up to move the at least one heating device, in particular all heating devices, together with the areas that can be heated, in particular inductively and/or resistively, and/or with the means for shaping and/or to reversibly reduce the cross section enclosed by them.

The tubing sealing device actuator advantageously has a cutting device for cutting through a tubing and/or at least one temperature sensor for measuring the temperature of the tubing and/or heating element.

Means for deforming and at least one induction coil are advantageously arranged in a one-piece tubing sealing device actuator. However, they can also be arranged in units that can be separated from one another, with the tubing sealing device actuator being set up in particular to connect these units firmly to one another.

The tubing sealing device actuator is advantageously designed with a supply part and an actuator part and an especially flexible connection lying between them. The supply part contains in particular the power supply and/or the actuator part in particular means for deforming and the heating device(s) and/or induction coil(s) and is designed in particular as pliers and/or with two jaws. In particular, the tubing sealing device actuator and in particular its actuator part has a joint on which two jaws and/or shanks are arranged, which in particular both have at least one heating device and/or induction coil(s). In particular, the jaws/shanks each have handles connected thereto for moving the jaws/legs and arranged on the opposite side of the joint and/or a locking mechanism for preventing relative movement of the jaws/shanks with respect to one another. In alternative embodiments, it may be preferred if the tubing sealing device actuator and in particular its actuator part is designed in two parts, with the parts being designed to be rigid and reversibly connectable to one another and reversibly separable from one another and both having means for deforming and at least one heating device and/or or induction coil(s). In alternative embodiments, it may be preferred if the tubing sealing device actuator and in particular its actuator part is C-shaped or U-shaped, with both opposite end sections each having means for deforming and at least one heating device and/or induction coil(s). A closure can also be provided which is set up to close the opening of the C-shape or the U-shape and/or to bring it into a rectangle or O-shape.

Preferably, the tubing sealing device actuator and/or its actuator part is/are at least IP68 compliant and/or is/are designed not to emit particles and/or have no fan and/or emit and/or generate no air flow.

In particular, the tubing sealing device actuator is set up to enclose all tubes with outside diameters in at least one fifth of the range from 3 mm to 45 mm, in particular with a heating element arranged around it, in particular a tubing heater according to the invention.

A possible embodiment of the invention is to be explained below purely schematically and not restrictively with reference to the following figures.

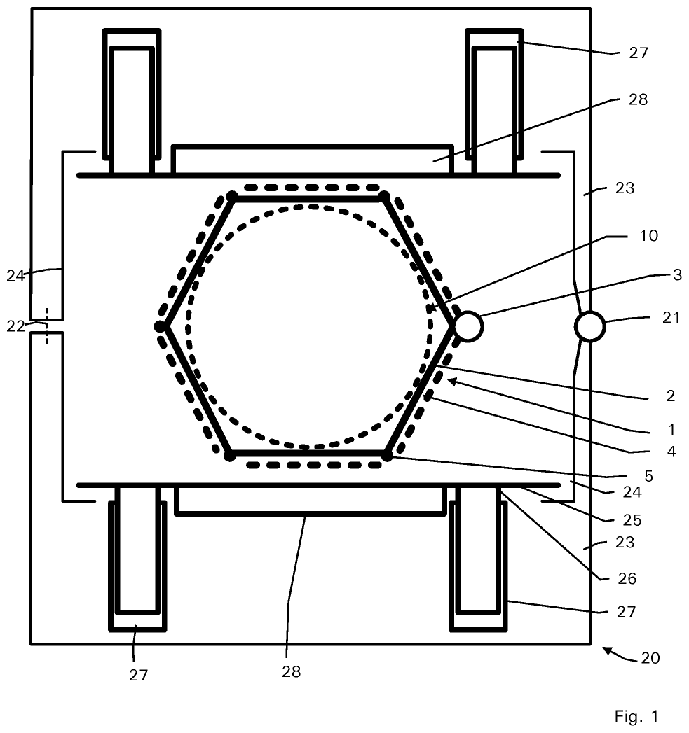

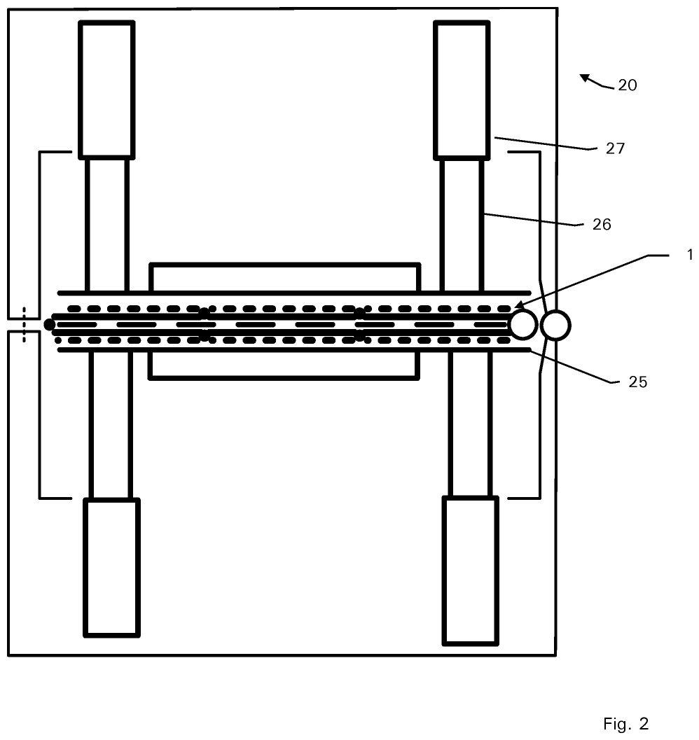

FIGS. 1 and 2 each show a cross-section through a sealer 20, also known as a tubing sealing device actuator. In FIG. 1, the sealer is arranged around a tubing 10 that is not closed or sealed. To the tubing 10 there is a tubing heater is arranged. The tubing heater has 3 inductively and/or resistively heatable plates 2, which were made from an aluminum strip by introducing weakened material 5. These plates are squeezed with a connector 3 to form a circumferential ring. A thermal insulation made of six ceramic insulation plates 4 is arranged around them. The heating plates rest on the tubing at six points evenly distributed around its circumference and enclose it completely.

The sealer 20 is formed with two jaws or sealer shanks 23 and a sealer hinge 21 lying between them. It has a closure 22 opposite the sealer hinge 21. Each leg has a pressure plate 25 running in guides 24, which can be moved via two stamps 26, each of a pneumatic cylinder 27. An induction coil arrangement 28 is connected to the pressure plate 25.

After the tubing 10 with the tubing heater 1 lying around it has been picked up and the closure 22 closed, the pressure plates 25 are brought into contact with the upper and lower insulation plates 4 by means of the pneumatic cylinders 27 and their stamps 26 and the heating plates 2 by means of the induction coil arrangements 28 heated. After the tubing 10 has softened by means of heating by the heating plates 2, the pressure plates 25 are moved towards one another by means of the pneumatic cylinders 27 and their plungers 26 together with the induction coil arrangements 28 and the tubing heater 1 is pressed together with further inductive heating and the tubing 10 is thereby closed. This can be seen in FIG. 2. Here the tubing 10 was flattened. The closure 22 can now be opened and the sealer shanks 23 can be folded apart and the sealer 20 removed. The tubing heater 1 stabilizes the still warm tubing 10 until it has completely cooled down.

### REFERENCE LIST

1 tubing heater
2 inductively heatable heating plates
3 connectors
4 isolation panel
5 hinge of 10 tubing
20 sealer
21 sealer hinge
22 closure
23 sealer shanks
24 guides
25 pressure plate
26 stamps
27 pneumatic cylinder
28 induction coil assembly

1. A tube heater for sealing thermoplastic hoses or tubes having at least one heatable heating element, the heating element having at least four electrically inductively or resistively heatable regions which are movable with respect to one another, said heating element being set up to be placed from a direction perpendicular to the longitudinal elongation onto a tube with an outside diameter and to enclose at least 75% of the tube's circumference while bearing against the tube over its circumference at at least four points which are spaced apart from one another, and wherein the heating element is deformable by compressing or pulling the heating element such that a cross-section enclosed by the heating element can be reduced by at least 30% or the heating element's elongation in one direction of the cross-section can be reduced by at least 30%, wherein the electrically inductively or resistively heatable regions are formed by plate-shaped element(s) and between at least two pairs of mutually adjacent plate-shaped elements there is in each case a joint or a weakening of the material which allows an angle of the plate-shaped elements of the respective pair to be changed relative to one another, wherein the outside diameter of the tube onto which the heating element is geared to be placed is in a range of 3 mm to 45 mm and in that the tube heater is designed to maintain the reduced enclosed cross-section at least against a force of 1 N pushing the tube heater apart at least to an extent that the reduced enclosed cross-section does not increase by more than 10%.

2. The tube heater according to claim 1, wherein the heating element has a thermal insulation around the electrically inductively or resistively heatable regions.

3. The tube heater according to claim 1, wherein the electrically inductively or resistively heatable heating element is arranged in only one layer around the cross-section enclosed by the heating element on at least half the circumference of the cross-section, or is wound a maximum of one and a half times around the cross-section enclosed by the heating element.

4. The tube heater according to claim 1, wherein the tube heater is flexible or has at least three joints or material weakenings or the electrically inductively or resistively heatable regions are each rigid, wherein the reduction of the cross section of the heating element is effected by changing the adjustment angles of adjacent electrically inductively or resistively, heatable regions via the at least three joints or material weakenings.

5. The tube heater according to claim 1, wherein the at least one tube heater or the electrically inductively or resistively heatable regions or heatable plates have a specific thermal capacity of less than 1000 J/K/kg.

6. The tube heater according to claim 1, wherein the tube heater severed in two parts with a gap in between, wherein the separation takes place parallel to the cross-sectional plane.

7. The tube heater according to claim 6, wherein each of the two parts intended for separation maintains its shape with reduced cross-section at least against a force of 1 N pushing the two parts apart.

8. The tube heater according to claim 1, wherein the tube heater has holes or recesses which are designed to allow thermoplastic material to pass through during compression.

9. A thermoplastic tube having a tube heater according to claim 1, in form of at least one electrically inductively or resistively heatable clasp or at least one, electrically inductively or resistively heatable ring which surrounds the tube, wherein the ring or clasp encloses at least 75% of the circumference of the tube while bearing against the tube over the tube's circumference at at least four points which are spaced apart from one another, and wherein the heating element is deformable such that a cross-section enclosed by the heating element is reduced by at least 30% or is reduced in the heating element's elongation in one direction of the cross-section by at least 30% by compressing or pulling the heating element, wherein the electrically inductively or resistively heatable regions which are movable with respect to one another are formed by plate-shaped element(s) and in between at least two pairs of mutually adjacent plate-shaped elements there is in each case a joint or a weakening of the material which allows an angle of the plate-shaped elements of the respective pair to be changed relative to one another, wherein the tube heater maintains the reduced enclosed cross-section at least against a force of 1 N pushing the tube heater apart at least to an extent that the reduced enclosed cross-section does not increase by more than 10%.

10. A tube closing device actuator in the form of tongs or of two jaws connected by a hinge, having means for receiving a tube heater having at least one electrically inductively or resistively heatable heating element, said heating element having at least four electrically inductively or resistively heatable regions which are movable with respect to one another, said heating element being set up to enclose a tube with an outside diameter in the range from 3 mm to 45 mm and to enclose the tube's circumference while bearing against the tube over its circumference at at least four points which are spaced apart from one another, and wherein the heating element is irreversibly or non-elastically deformable, wherein a cross-section enclosed by the heating element is reduced or flattened by at least 30% according to with the tube and the means for receiving the tube comprising at least one hydraulic or pneumatic cylinder arranged for deforming the tube heater in such a way that the cross-section enclosed by the tube heater is reduced by at least 30%, wherein the tube closing device actuator has at least one means for effecting inductive or resistive heating of the heating element.

11. A tube closing device actuator in the form of tongs or of two jaws connected by a hinge, for closing thermoplastic tubes having at least one electrically inductively or resistively heatable heating element, wherein the at least one heating element has at least four heatable regions which are movable with respect to one another, and that the at least one heating element is set up to be placed from a direction perpendicular to the longitudinal elongation onto a tube with an outside diameter in a range from 3 mm to 45 mm, and to enclose at least 75% of the tube's circumference while bearing against the tube over its circumference at at least four points which are spaced apart from one another, and wherein the tube closing device actuator is set up to move the at least one heating element in such a way that a cross-section enclosed by the at least one heating element is reduced by at least 30% or is reduced in the heating element's elongation in one direction of the cross-section by at least 30%, wherein the tube closing device actuator has at least one induction coil for electrical, inductive heating or one heating device for resistive heating of the at least one heating element.

12. The tube closing device actuator according to claim 11 having at least one cutting device for cutting the tube or at least one temperature sensor.

13. A tube closing system having at least one tube heater according to claim 1, at least one tube tube closing device actuator.

14. Method A method for closing a thermoplastic tube according to claim 9, comprising the following steps:
at least partial enclosing of a section of the tube with at least one electrically inductively or resistively, heatable heating element or use of the thermoplastic tube with the electrically inductively or resistively, heatable heating element enclosing the tube, said at least one heating element bearing at least partially on the circumference of the tube, and enclosing the tube or the heating element on at least two mutually opposite sides on or adjacent to a section of the tube with a means for compressing the tube;
heating the at least one heating element and heating the tube with the at least one heated heating element, until for a wall of the section of the tube, the Shore A hardness is reduced by at least 30% or a glass temperature is reached or a glass transition temperature is reached;
compressing the tube with the means for compressing the tube; and
removing the means for compression and.

15. A use of at least one electrically inductively or resistively heatable heating element for closing a thermoplastic tube in accordance with claim 9, wherein a section of the thermoplastic tube is or becomes enclosed by the at least one electrically inductively or resistively heatable heating element and the at least one heating element is heated and thus the section of the thermoplastic tube is heated, until at least at the circumference, the Shore A hardness of the section is reduced by at least 30% or until at least at the circumference, a glass temperature or a glass transition temperature is reached, and compressing the hose in or adjacent to the section while heating of the at least one heating element or heating of the section with the heated at least one heating element is continued.

16. The tube heater according to claim 2, wherein the thermal insulation is severed in two parts with a gap in between, wherein the separation takes place parallel to the cross-sectional plane.

17. The tube heater according to claim 16, wherein each of the two parts intended for separation maintains its shape with reduced cross-section at least against a force of 1 N pushing the two parts apart.

18. The tube closing device actuator according to claim 11, wherein the tube closing device actuator is set up to move the at least one heating element by means of at least one hydraulic or pneumatic cylinder.

19. The method according to claim 14, wherein the tube is heated until for the entire thickness of the wall, at least at the circumference thereof, the Shore A hardness is reduced by at least 30% or the glass temperature is reached or the glass transition temperature is reached.

20. The method according to claim 14, further comprising:
compressing the tube while continuing to heat the at least one heating element or continuing to heat the section of the tube with the heated heating element; and
removing the means for compression and the at least one heating element.
